(19) United States
(12) Patent Application Publication
(10) Pub. No.: US 2025/0210890 A1
(43) Pub. Date: Jun. 26, 2025

(54) TERMINAL FITTING AND CONNECTOR

(71) Applicant: SUMITOMO WIRING SYSTEMS, LTD., Mie (JP)

(72) Inventor: Koji IIDA, Mie (JP)

(21) Appl. No.: 18/850,563

(22) PCT Filed: Mar. 7, 2023
(86) PCT No.: PCT/JP2023/008471

§ 371 Date: Sep. 25, 2024

(30) Foreign Application Priority Data
Mar. 28, 2022 (JP) 2022-051981

(51) Int. Cl. H01R 12/58; H01R 13/04; H01R 13/516

(52) U.S. Cl. CPC H01R 12/585; H01R 13/04; H01R 13/516

(57) ABSTRACT

A terminal fitting (60, 60C, 60D, 60E) includes a partner connection portion (61) to be connected to a partner's conductor, in a portion on one end side in the lengthwise direction of the terminal fitting, a housing attachment portion (62) to be attached to a housing (20) at an intermediate position in the lengthwise direction of the terminal fitting, a board connection portion (66) to be connected to a circuit board (100) through soldering, in a portion on the other end side in the lengthwise direction, and a protruding portion (68, 68D) that protrudes, from a position between a housing attachment portion (62) and a board connection portion (66), in a direction that faces a circuit board (100) and intersects the lengthwise direction.

### TECHNICAL FIELD

The present disclosure relates to a terminal fitting and a connector.

### BACKGROUND

A connector disclosed in Patent Document 1 includes a housing and a terminal fitting (contact). The terminal fitting has a shape extending in a lengthwise direction. A soldering tine portion that is connected to a circuit board through soldering is provided at an end portion in the lengthwise direction of the terminal fitting, and a bulging portion that is press-fitted into the housing is provided at an intermediate position in the lengthwise direction of the terminal fitting. In addition, the terminal fitting includes a contact pin at an end portion on the opposite side to the soldering tine portion in the lengthwise direction. A connector that includes a terminal fitting to be connected to a circuit board is also disclosed in Patent Documents 2-4.

### PRIOR ART DOCUMENT

### Patent Document

Patent Document 1: JP H07-272803 A
Patent Document 2: JP 3094554 U
Patent Document 3: JP 2011-249154 A
Patent Document 4: JP 2020-035748 A

### SUMMARY OF THE INVENTION

### Problems to Be Solved

In the case of Patent Document 1, a plurality of terminal fittings are separated into two levels, namely upper and lower levels and are attached to the housing. Of these levels, the height different between the soldering tine portion and the bulging portion of each of the terminal fittings at the lower-level is small, and thus there is a concern that a soldering material that includes solder, flux, and the like on the circuit board will flow to the bulging portion side without remaining on the soldering tine portion, and further wet up to a leading end side of the contact pin on the opposite side to the soldering tine portion. There has been a problem in that the reliability of electrical connection of the terminal fitting is compromised if the soldering material adheres to the leading end side of the contact pin.

In view of this, an object of the present disclosure is to provide a terminal fitting and a connector that can ensure electrical connection reliability.

### Means to Solve the Problem

A terminal fitting according to the present disclosure is a terminal fitting that extends in a lengthwise direction, and includes: a partner connection portion to be connected to a partner's conductor, in a portion on one end side in the lengthwise direction of the terminal fitting, a housing attachment portion to be attached to a housing at an intermediate position in the lengthwise direction of the terminal fitting, a board connection portion to be connected to a circuit board through soldering, in a portion on the other end side in the lengthwise direction, and a protruding portion that protrudes, from a position between the housing attachment portion and the board connection portion, in a direction that faces the circuit board and intersects the lengthwise direction.

A connector according to the present disclosure includes the above terminal fitting and the housing, the housing includes a hood portion, and the partner connection portion protrudes into the hood portion.

### Effect of the Invention

According to the present disclosure, it is possible to provide a terminal fitting and a connector that can ensure electrical connection reliability.

### BRIEF DESCRIPTION OF THE DRAWINGS

FIG. 1 is a rear view of a connector according to a first embodiment of the present disclosure.

FIG. 2 is a plan view of the connector.

FIG. 3 is a cross-sectional view taken along the line A-A in FIG. 2.

FIG. 4 is an enlarged cross-sectional view of a terminal fitting to be connected to a circuit board through soldering.

FIG. 5 is a perspective view of a first terminal.

FIG. 6 is a perspective view of a second terminal.

FIG. 7 is an enlarged side view of a terminal fitting to be connected to a circuit board through soldering according to a second embodiment of the present disclosure.

FIG. 8 is a perspective view of a terminal fitting according to a third embodiment of the present disclosure.

FIG. 9 is an enlarged cross-sectional view of the terminal fitting to be connected to a circuit board through soldering according to the third embodiment.

FIG. 10 is an enlarged side view of a terminal fitting to be connected to a circuit board through soldering according to a fourth embodiment of the present disclosure.

FIG. 11 is an enlarged plan view of the terminal fitting to be connected to the circuit board through soldering according to the fourth embodiment.

### DETAILED DESCRIPTION TO EXECUTE THE INVENTION

### Description of Embodiments of the Disclosure

First, embodiments of the present disclosure will be listed and described.

(1) A terminal fitting according to the present disclosure is: a terminal fitting that extends in a lengthwise direction, and includes: a partner connection portion to be connected to a partner's conductor, in a portion on one end side in the lengthwise direction of the terminal fitting, a housing attachment portion to be attached to a housing at an intermediate position in the lengthwise direction of the terminal fitting, a board connection portion to be connected to a circuit board through soldering, in a portion on the other end side in the lengthwise direction, and a protruding portion that protrudes, from a position between the housing attachment portion and the board connection portion, in a direction that faces the circuit board and intersects the lengthwise direction.

The terminal fitting configured as described above can stop a soldering material that includes solder, flux, and the like using the protruding portion, and thus it is possible to ensure the electrical connection reliability.

(2) Preferably, a lower end thereof that opposes the circuit board includes an inclined portion that is inclined upward from the board connection portion to a base end of the protruding portion.

With the above configuration, the inclined portion is inclined upward, and thus, even during a period until the soldering material reaches the protruding portion, it is possible to keep the soldering material from wetting.

(3) Preferably, a height position of an end portion on the inclined portion side of a base end of the protruding portion is set higher than a height position of an end portion on the opposite side to the inclined portion side.

With the above configuration, it is possible to increase the height difference between the end portion on the inclined portion side and the circuit board, and thus it is possible to further keep a soldering material from wetting during a period until when the soldering material reaches the protruding portion.

(4) Preferably, the terminal fitting is shaped as a plate extending along the lengthwise direction, and the lower end thereof that opposes the circuit board is a plate thickness surface.

With the above configuration, when a plurality of terminal fittings are attached to the housing in a state where plate surfaces of adjacent terminal fittings oppose each other, it is possible to close a pitch between the terminal fittings.

(5) Preferably, a rib that extends in a direction that intersects the lengthwise direction is formed on a plate surface of the protruding portion.

With the above configuration, even when the soldering material is about to move to the housing attachment portion side along the plate surface of the protruding portion, the rib can stop the soldering material, and it is possible to further improve the electrical connection reliability.

(6) A connector according to the present disclosure includes: the terminal fitting according to any one of the above (1) to (5); and the housing, and the housing includes a hood portion, and the partner connection portion protrudes into the hood portion.

With the above configuration, it is possible to fit the partner connector into the hood portion, and connect the partner's conductor attached to the partner connector to the partner connection portion.

(7) Preferably, the housing includes a plurality of terminal insertion holes, the housing attachment portion is accommodated in one of the terminal insertion holes, and, when the housing is disposed on a surface of the circuit board, at least one of the plurality of terminal insertion holes is disposed within a plate thickness range of the circuit board, or is disposed on a lower side relative to a back surface of the circuit board.

With the above configuration, the height difference between the housing attachment portion and the board connection portion is small, and thus the soldering material is likely to move from the board connection portion to the housing attachment portion side. However, the protruding portion can stop the soldering material, and thus, even when the height difference is small, it is possible to avoid wetting of the soldering material to the partner connection portion.

### Detailed Embodiments of Present Disclosure

Specific examples of the present disclosure will be described below with reference to the drawings. Note that the present invention is not limited to illustrations of these, but is indicated by the claims, and is intended to include all modifications that are within the meanings and the scope that are equivalent to those of the claims.

### First Embodiment

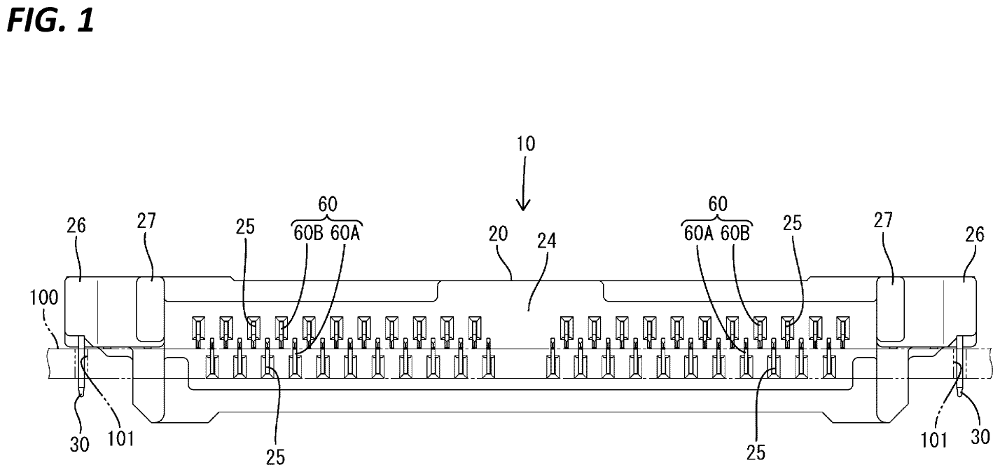

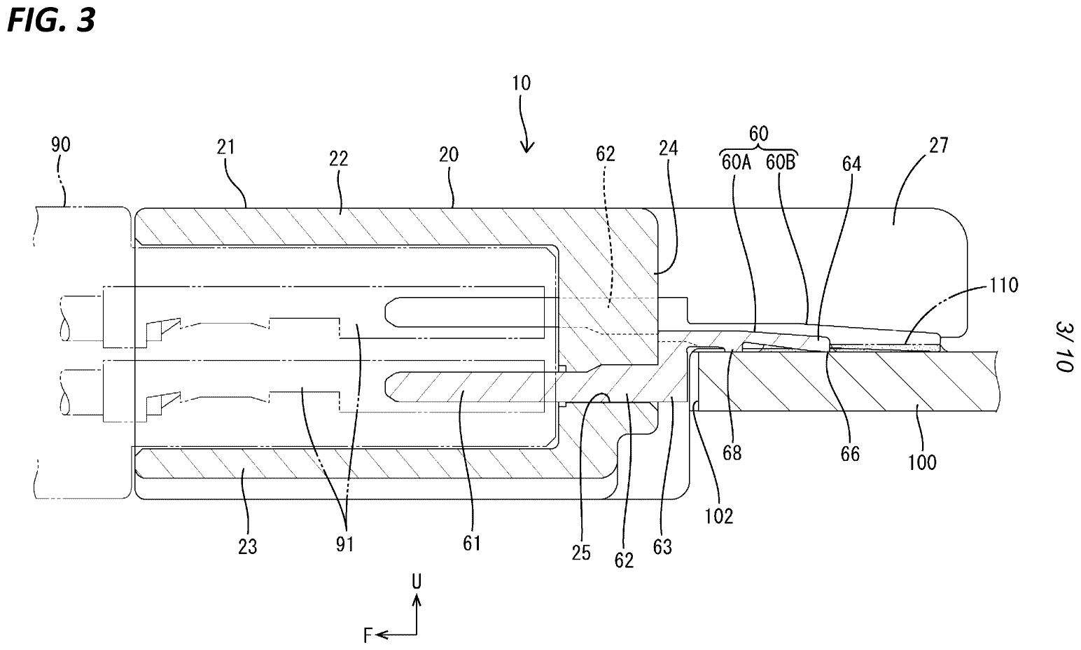

A connector 10 according to a first embodiment of the present disclosure is a board connector to be mounted on a circuit board 100. As shown in FIGS. 1 to 3, the connector 10 includes a housing 20, and a plurality of terminal fittings 60 that are attached to the housing 20. As shown in FIG. 3, the housing 20 can be fitted to a partner connector 90. Note that, in the following description, in the front-rear direction, the side of a surface of the housing 20 that faces the partner connector 90 when the housing 20 starts to be fitted is defined as a front side. In the up-down direction, the side on which the housing 20 is disposed (mounted) on the circuit board 100 is defined as an upper side. The concept of the up-down direction is for the purpose of convenience, and does not necessarily match the up-down direction in a state where the connector 10 is mounted in a vehicle or the like. The left-right direction is based on the left-right direction in FIG. 1. The left-right direction is synonymous with the width direction. In FIG. 3, reference numeral F indicates the front side, and reference numeral U indicates the upper side. In addition, in the following description, an “end portion” refers to a portion on an end side in the front-rear direction or the up-down direction in the cross-sectional view in FIG. 3, and an “end” refers to the “most-leading end of an end portion”.

### Housing

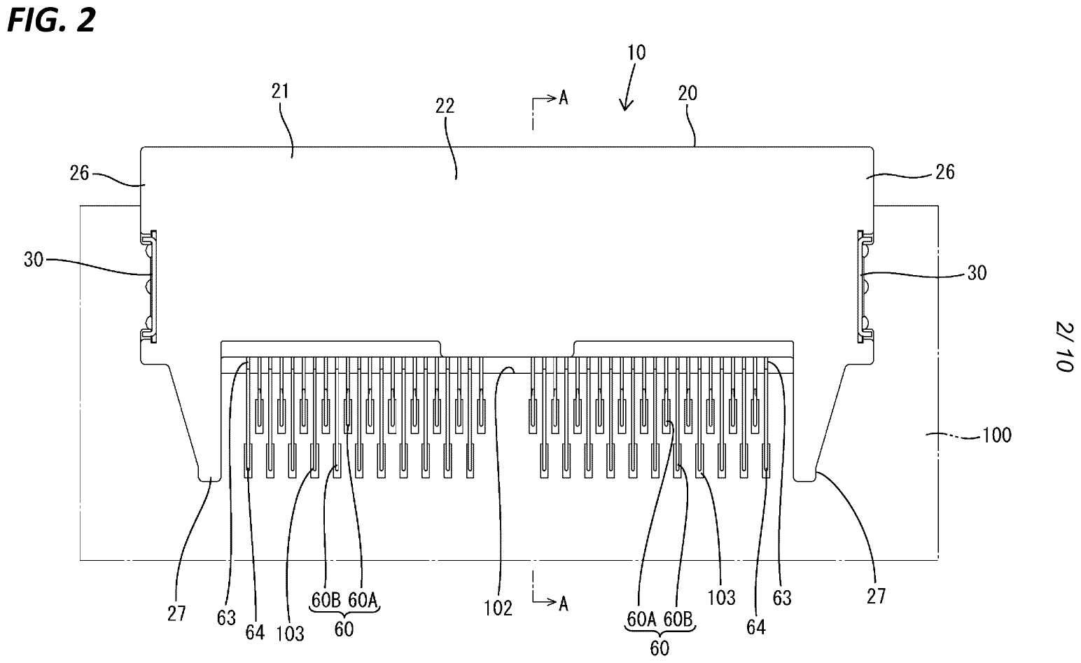

As shown in FIG. 3, the housing 20 includes a hood portion 21 that is open on the front side. The hood portion 21 is shaped as a flattened rectangular tube that is elongated in the left-right direction (see FIGS. 1 and 2). As shown in FIG. 3, an upper wall 22 of the hood portion 21 is disposed on the upper side relative to the circuit board 100 in the up-down direction. A lower wall 23 of the hood portion 21 is disposed on the lower side relative to the circuit board 100 in the up-down direction. A rear wall 24 of the hood portion 21 connects rear end portions of the upper wall 22 and the lower wall 23 on the front side relative to the circuit board 100.

As shown in FIG. 1, a plurality of terminal insertion holes 25 are formed in the rear wall 24. The terminal insertion holes 25 each have a slit-shaped opening cross-section elongated in the up-down direction. The terminal insertion holes 25 are formed in the rear wall 24 in two levels, namely upper and lower levels, and are aligned in the left-right direction. The terminal insertion holes 25 at the upper level and the terminal insertion holes 25 at the lower level are displaced from each other by half a pitch in the left-right direction. The terminal insertion holes 25 at the upper level are disposed slightly on the upper side relative to the surface of the circuit board 100 in the up-down direction. As shown in FIG. 3, the terminal insertion holes 25 at the lower level are disposed on the front side relative to one end 102 of the circuit board 100, at positions overlapping the plate thickness range of the circuit board 100 in the up-down direction.

As shown in FIGS. 1 and 2, the hood portion 21 has fixing portions 26 respectively on the right and left side walls thereof. The fixing portions 26 are disposed on the surface of the circuit board 100. Fixing members 30 are respectively attached to the fixing portions 26. The fixing members 30 are each a metal plate material, and, as shown in FIG. 1, protrude downward respectively from the fixing portions 26, and are inserted into fixing holes 101 of the circuit board 100 and fixed to the circuit board 100 through soldering. The housing 20 is held on the circuit board 100 via the fixing members 30.

As shown in FIG. 2, the housing 20 includes protection walls 27 that protrude rearward respectively from the right and left sides of the hood portion 21. The protection walls 27 are each shaped as a plate, and are disposed with plate surfaces thereof facing the left-right direction. The protection walls 27 are disposed on the surface of the circuit board 100. Later-described curved portions 63 and extended portions 64 of the terminal fittings 60 are disposed between the protection walls 27.

### Terminal Fittings

Each terminal fitting 60 is electrically conductive, and is formed by punching one metal plate. As shown in FIG. 3, the terminal fitting 60 is constituted by two types of terminals, namely a first terminal 60A that extends from a front end thereof to a rear end in the lengthwise direction and a second terminal 60B that extends from a front end thereof to a rear end in the lengthwise direction, longer than the first terminal 60A.

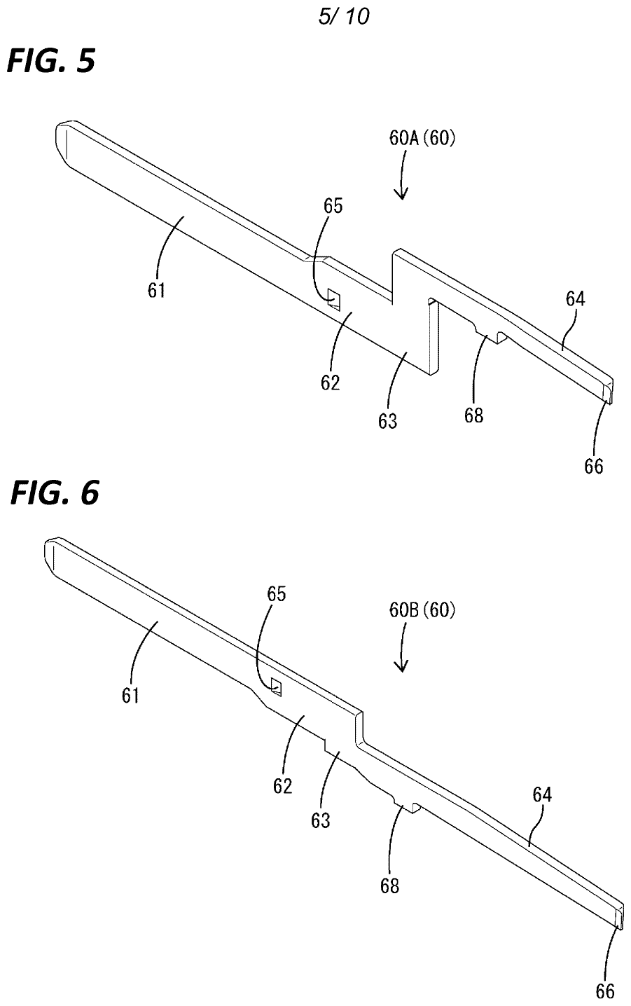

The first terminal 60A is shaped as s belt-like plate, and is disposed with plate surfaces thereof facing the left-right direction as a whole in a state of being attached to the housing 20. As shown in FIG. 5, the first terminal 60A includes a partner connection portion 61, a housing attachment portion 62, a curved portion 63, and an extended portion 64 that are integrally continuous to each other in the front-rear direction without any step along the plate surfaces of the first terminal 60A.

As shown in FIG. 3, in the front end portion of the first terminal 60A, the partner connection portion 61 protrudes into the hood portion 21. The housing attachment portion 62 is disposed rearward of the partner connection portion 61, and is press-fitted into the terminal insertion hole 25 at the lower level and is held, in a case of the first terminal 60A. The housing attachment portion 62 is formed higher than the partner connection portion 61.

As shown in FIG. 5, the housing attachment portion 62 includes a latching protrusion 65. The latching protrusion 65 is formed by cutting a portion of the housing attachment portion 62 and raising the portion to one of the right and left sides (in the case of FIG. 5, further side in the figure). This latching protrusion 65 is latched to an inner surface of the terminal insertion hole 25 in the rear wall 24 of the hood portion 21. The first terminal 60A is held on the housing 20 by the latching protrusion 65 being latched to the rear wall 24.

As shown in FIG. 3, in a case of the first terminal 60A, on the rear side relative to the housing attachment portion 62, the curved portion 63 is continuous to and protrude upward from the housing attachment portion 62. The front end of the curved portion 63 is disposed such that it can come into contact with the rear surface of the hood portion 21 along the up-down direction. The rear end of the curved portion 63 (excluding an upper portion to be described later) opposes the one end 102 of the circuit board 100 with a space therebetween along the up-down direction.

The extended portion 64 extends rearward from the upper end side of the rear end of the curved portion 63 that does not oppose the one end 102 of the circuit board 100. The extended portion 64 is disposed on the surface of the circuit board 100.

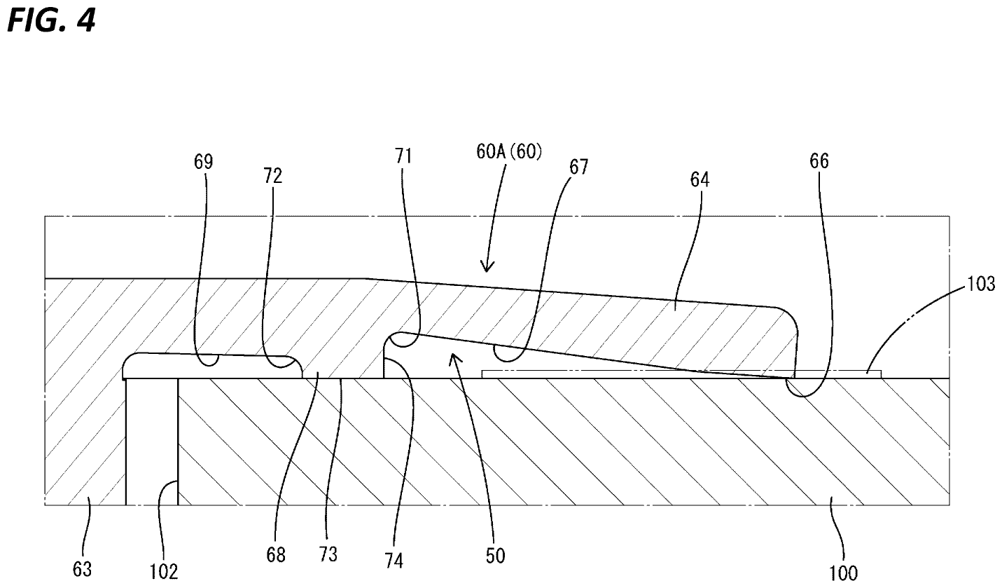

As shown in FIG. 4, a board connection portion 66 that is connected to a soldering portion 103 (a portion where solder paste is applied) formed on the surface of the circuit board 100 is provided on the rear end portion of the extended portion 64. The rear end of the board connection portion 66 is disposed such that a corner thereof abuts on the soldering portion 103 of the circuit board 100. An area in which the board connection portion 66 is formed is defined by the lower end portion of the extended portion 64 that opposes the soldering portion 103. An inclined portion 67 that is inclined upward toward the front is provided on a segment of the lower end of the extended portion 64 that includes the board connection portion 66. The front end of the inclined portion 67 is disposed at the highest position of the lower end of the extended portion 64. The size in the up-down direction (height and plate width) of a portion of the extended portion 64 that corresponds to the inclined portion 67 decreases toward the front.

As shown in FIG. 4, a protruding portion 68 that protrudes downward is formed on the extended portion 64. A portion of the lower end of the extended portion 64 that is positioned on the opposite side to the inclined portion 67 with the protruding portion 68 therebetween is formed as a straight-line portion 69 that forms a smaller inclination angle with respect to the front-rear direction than the inclined portion 67, or disposed horizontally without being inclined.

A base end in the protruding direction of the protruding portion 68 includes a rear end portion 71 that is curved and continuous to the front end of the inclined portion 67 and a front end portion 72 that is curved and continuous to the rear end of the straight-line portion 69. The rear end portion 71 is disposed on the upper side relative to the front end portion 72. A lower end, namely a leading end in the protruding direction of the protruding portion 68 is formed as a board creepage portion 73 that comes into contact with or is close to the surface of the circuit board 100. The board creepage portion 73 of the protruding portion 68 is disposed along the front-rear direction in parallel to the surface of the circuit board 100. The rear end of the protruding portion 68 is formed as an upright portion 74 disposed along the up-down direction, between the rear end portion 71 and the board creepage portion 73. The rear end portion 71, the front end portion 72, the board creepage portion 73, and the upright portion 74 are all plate thickness surfaces of the terminal fitting 60.

As shown in FIG. 6, the second terminal 60B is also shaped as a belt-like plate with plate surfaces thereof facing the left-right direction, and includes a partner connection portion 61, a housing attachment portion 62, a curved portion 63, and an extended portion 64 similarly to the first terminal 60A. The extended portion 64 of the second terminal 60B also includes a protruding portion 68 and a board connection portion 66 with an aspect similar to that of the extended portion 64 of the first terminal 60A. As shown in FIG. 3, the housing attachment portion 62 is press-fitted into the terminal insertion hole 25 at the upper level, and is held. As shown in FIG. 6, the curved portion 63 of the second terminal 60B is continuous to and protrudes downward from the housing attachment portion 62, inversely to the curved portion 63 of the first terminal 60A. The distance between the protruding portion 68 and the rearmost end of the board connection portion 66 of the extended portion 64 of the second terminal 60B is longer than that of the first terminal 60A.

### Effects of Terminal Fitting and Connector

At the time of attachment, by the housing attachment portion 62 of the first terminal 60A being press-fitted into the terminal insertion hole 25 at the lower level, the housing attachment portion 62 and the partner connection portion 61 of the first terminal 60A are disposed at height positions that overlap the plate thickness range of the circuit board 100 in the up-down direction, as shown in FIG. 3. In addition, by the housing attachment portion 62 of the second terminal 60B being press-fitted into the terminal insertion hole 25 at the upper stage, the housing attachment portion 62 and the partner connection portion 61 of the second terminal 60B are disposed slightly on the upper side relative to the circuit board 100 in the up-down direction.

As shown in FIG. 4, the board connection portion 66 of the extended portion 64 is disposed such that it can come into contact with the soldering portion 103 of the circuit board 100. The board creepage portion 73 of the protruding portion 68 is disposed in contact with or close to a segment of the surface of the circuit board 100 that is on the front side relative to the soldering portion 103.

When reflow processing is performed on the circuit board 100 on which the connector 10 is placed, a soldering material 110 that includes solder, flux, and the like (see FIG. 3) on the soldering portion 103 melts and adheres to the board connection portion 66, and the board connection portion 66 is connected to the soldering portion 103. At the same time, the fixing members 30 are fixed to the circuit board 100 through soldering, and the connector 10 is mounted on the circuit board 100.

The soldering material 110 that has melted can wet in space 50 (see FIG. 4) between the circuit board 100 and the extended portion 64 through capillary phenomenon, and flow from the board connection portion 66 to the housing 20 side along the inclined portion 67.

In the case of the first embodiment, the height difference between the partner connection portion 61, the housing attachment portion 62, and the board connection portion 66 is small, and thus there is a concern that the soldering material 110 will move from the board connection portion 66 to the partner connection portion 61 through the housing attachment portion 62. However, between the housing attachment portion 62 and the board connection portion 66, the protruding portion 68 protrudes toward the surface side of the circuit board 100. For this reason, the soldering material 110 is stopped by the protruding portion 68, and thus can be prevented from moving forward beyond the protruding portion 68. Specifically, even when the soldering material 110 flows forward along the inclined portion 67, the soldering material 110 can remain in the space 50 by coming into contact with an area extending from the rear end portion 71 to the upright portion 74. Thus, it is possible to avoid a situation where the soldering material 110 passes through the housing attachment portion 62 and wets up to the partner connection portion 61. In particular, the soldering material 110 moves upward along the inclined portion 67, and, in addition, the rear end portion 71 is disposed at a higher position than the front end portion 72, and thus wetting can also be suppressed during a period until the soldering material 110 reaches the protruding portion 68.

The partner connector 90 is fitted into the hood portion 21. As shown in FIG. 3, a partner terminal fitting 91 that is a partner's conductor and is attached to the partner connector 90 is connected to the partner connection portion 61 in the hood portion 21. In the first embodiment, as described above, it is possible to reliably realize a state where the soldering material 110 does not adhere to the partner connection portion 61, and thus it is possible to ensure the reliability of connection between the partner terminal fitting 91 and the terminal fitting 60.

In addition, in the case of the first embodiment, each terminal fitting 60 is disposed in a state where the plate thickness surfaces of the lower end thereof face the circuit board 100, and the plate surfaces thereof face the left-right direction, and thus the terminal fittings 60 are attached to the rear wall 24 of the hood portion 21 with a pitch in the left-right direction closed. For this reason, the connector 10 according to the first embodiment can handle the multipolarization of terminal fittings 60.

### Second Embodiment

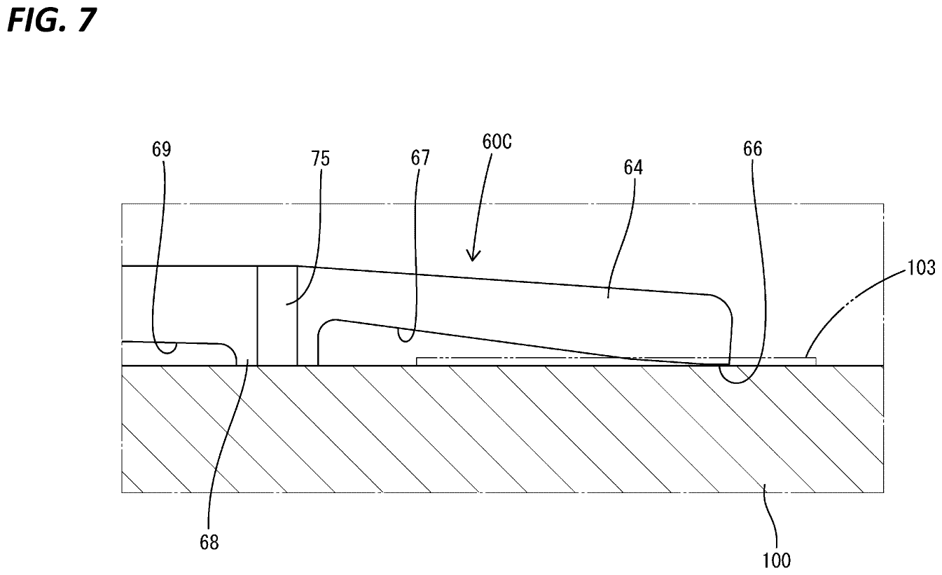

A terminal fitting 60C according to a second embodiment of the present disclosure is different from the terminal fitting 60 in that, as shown in FIG. 7, ribs 75 are added to the protruding portion 68 according to the first embodiment. Except for that, the second embodiment is similar to the first embodiment.

The ribs 75 extend and protrude in the up-down direction respectively from the right and left plate surfaces of the extended portion 64 (FIG. 7 only shows one plate surface). Specifically, the ribs 75 are formed at positions of the right and left plate surfaces of the extended portion 64 that correspond to the protruding portion 68, and are formed in areas extending from the upper end of the extended portion 64 to the lower end of the protruding portion 68 (board creepage portion) throughout the whole height. By performing pressing processing on portions on the rear end side of the right and left plate surfaces of the extended portion 64 that include the board connection portion 66 and portions on the front end side, the ribs 75 are formed to be thick between the portions on the rear end side and the front end side. The lower ends of the ribs 75 are disposed in contact with or close to the surface of the circuit board 100.

In a case of the second embodiment, even when, in a process of reflow processing, the soldering material 110 that has melted moves around a plate surface of the extended portion 64, the soldering material 110 on the plate surface can be stopped by the rib 75. Thus, according to the second embodiment, it is possible to more reliably prevent the soldering material 110 from moving forward beyond the protruding portion 68, and prevent the soldering material 110 from coming into contact with the partner connection portion 61. As a result, it is possible to further improve the reliability of connection between the partner connection portion 61 and the partner terminal fitting 91.

### Third Embodiment

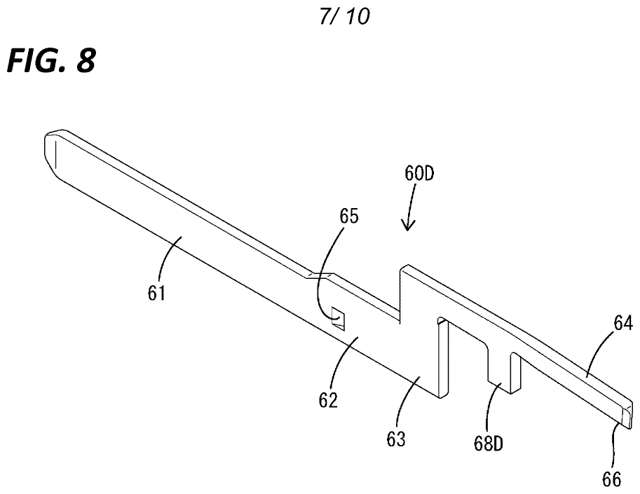

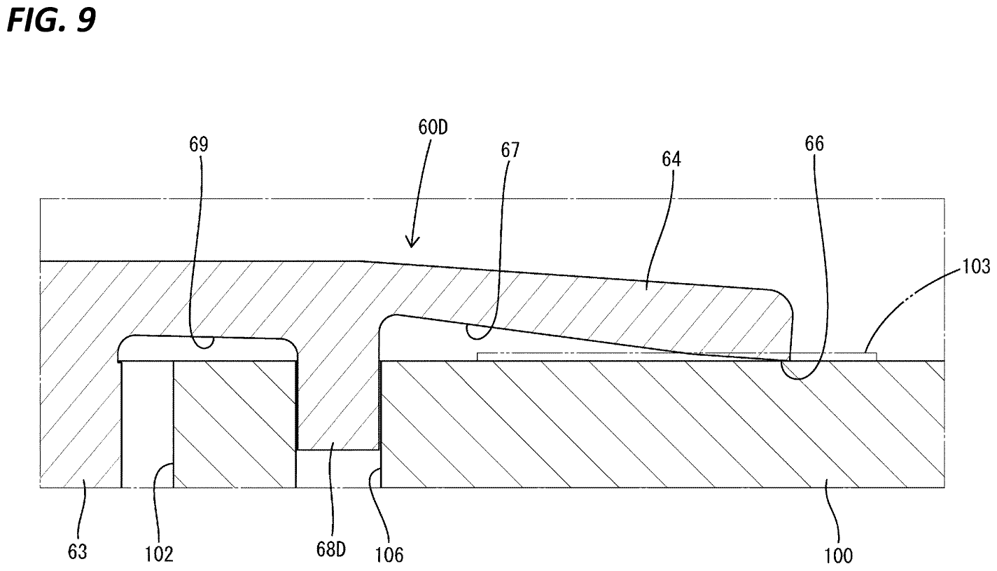

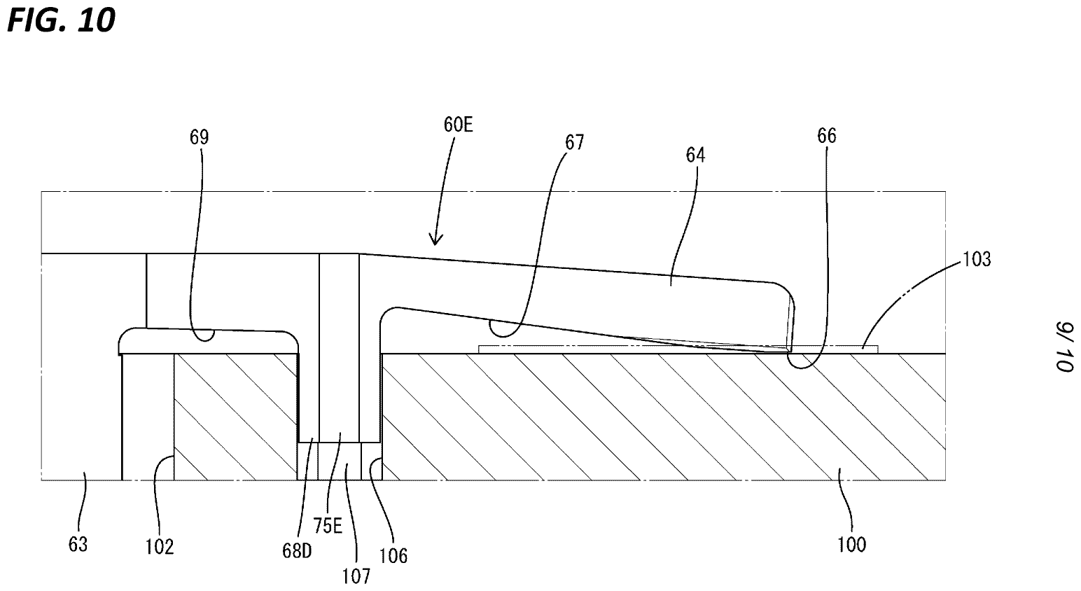

A terminal fitting 60D according to a third embodiment of the present disclosure is different from the first terminal 60A according to the first embodiment in that, as shown in FIGS. 8 and 9, the protruding length of a protruding portion 68D is longer compared with that of the first terminal 60A. In addition, as shown in FIG. 9, an insertion hole 106 into which a lower end portion of the protruding portion 68D can be inserted is formed in the circuit board 100. Except for that, the third embodiment is similar to the first embodiment.

The lower end portion of the protruding portion 68D is disposed on the lower side relative to the board connection portion 66 of the extended portion 64 in the up-down direction. The insertion hole 106 is suitable for the cross-sectional shape of the protruding portion 68D, and is shaped as a slit elongated in the front-rear direction. In the case of the third embodiment, as shown in FIG. 9, the lower end portion of the protruding portion 68D is inserted into the insertion hole 106 in a fitted state. Accordingly, the terminal fitting 60D is disposed on the circuit board 100 in a state where displacement thereof in the left-right direction is restricted. Thus, according to the third embodiment, it is possible to stabilize a state where the terminal fitting 60D is mounted on the circuit board 100.

### Fourth Embodiment

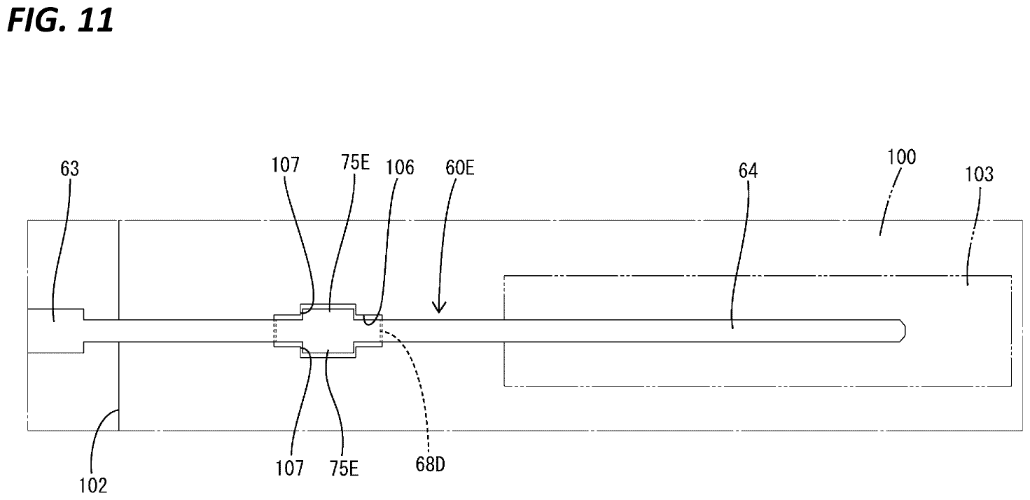

A terminal fitting 60E according to a fourth embodiment of the present disclosure is different from the terminal fitting 60D in that ribs 75E are added to the protruding portion 68D according to the third embodiment, as shown in FIGS. 10 and 11. In addition, as shown in FIG. 11, an intersection hole 107 into which lower end portions of the ribs 75E can be inserted is formed in the circuit board 100. Except for that, the fourth embodiment is similar to the third embodiment.

Similarly to the second embodiment, the ribs 75E extend and protrude in the up-down direction, at positions of the right and left plate surfaces of the extended portion 64 that correspond to the protruding portion 68D. As shown in FIG. 11, the intersection hole 107 intersects the insertion hole 106, and the width of the intersection hole 107 is large on the right and left sides. The insertion hole 106 and the intersection hole 107 in the circuit board 100 have an opening cress-section that has a cross shape, in correspondence with the cross-sectional shape of the protruding portion 68D and the ribs 75E.

According to the fourth embodiment, similarly to the second embodiment, it is possible to favorably keep the soldering material from wetting to the partner connection portion 61 using the ribs 75E. In addition, according to the fourth embodiment, by the lower end portion of the protruding portion 68D being inserted into the insertion hole 106 in a fitted state, it is possible to restrict displacement of the terminal fitting 60E in the left-right direction similarly to the third embodiment. Furthermore, according to the fourth embodiment, by the lower end portions of the ribs 75E being inserted into the intersection hole 107 in a fitted state, it is also possible to restrict displacement of the terminal fitting 60E in the front-rear direction. Thus, according to the fourth embodiment, it is possible to further increase the stability of a state where the terminal fitting 60E is mounted on the circuit board 100.

### Other Embodiments of Present Disclosure

The first to fourth embodiments disclosed herein are exemplary in all respects and should not be interpreted as limiting.

In the cases of the first to fourth embodiments, the terminal fitting is formed in a plate shape with plate surfaces thereof facing the left-right direction. However, according to another embodiment, each terminal fitting may be formed in a plate shape with plate surfaces thereof facing the up-down direction, or may be formed in a pin-shape.

In the cases of the first to fourth embodiments, the board connection portion is formed at a rear end (rearmost end) of the extended portion of the terminal fitting. However, according to another embodiment, it suffices for the board connection portion to be formed at a portion on the rear end side of the terminal fitting, or the board connection portion may be formed on the front side relative to the rear end of the extended portion.

In the case of the first embodiment, the connection partner of the partner connection portion is a partner's terminal fitting. However, according to another embodiment, a connection partner of a partner connection portion may be a partner's circuit board or the like.

In the case of the first embodiment, the terminal insertion holes at the lower level are disposed at height positions that overlap the plate thickness range of the circuit board. According to another embodiment, terminal insertion holes may be disposed on the lower side relative to the back surface of a circuit board.

In the case of the first embodiment, the housing attachment portion of each terminal fitting is inserted into a terminal insertion hole of the housing. However, according to another embodiment, a housing attachment portion of a terminal fitting may be attached to a rear wall of a housing through insert molding.

### List of Reference Numerals

10 Connector
20 Housing
21 Hood portion
22 Upper wall
23 Lower wall
24 Rear wall
25 Terminal insertion hole
26 Fixing portion
27 Protection wall
30 Fixing member
50 Space
60, 60C, 60D, 60E Terminal fitting
60A First terminal
60B Second terminal
61 Partner connection portion
62 Housing mount portion
63 Bent portion
64 Extended portion
65 Latching protrusion
66 Board connection portion
67 Inclined portion
68, 68D Protruding portion
69 Straight-line portion
71 Rear end portion
72 Front end portion
73 Board creepage portion
74 Upright portion
75, 75E Rib
90 Partner connector
91 Partner terminal fitting
100 Circuit board
101 Fixing hole
102 One end
103 Soldering portion
106 Insertion hole
107 Intersection hole
110 Soldering material

1. A terminal fitting that extends in a lengthwise direction, comprising:
a partner connection portion to be connected to a partner's conductor, in a portion on one end side in the lengthwise direction of the terminal fitting;
a housing attachment portion to be attached to a housing at an intermediate position in the lengthwise direction of the terminal fitting;
a board connection portion to be connected to a circuit board through soldering, in a portion on the other end side in the lengthwise direction; and
a protruding portion that protrudes, from a position between the housing attachment portion and the board connection portion, downward, namely in a direction that faces the circuit board and intersects the lengthwise direction,
wherein a lower end of the protruding portion is positioned at the same height as a lower end of the board connection portion.

2. A terminal fitting that extends in a lengthwise direction, comprising:
a partner connection portion to be connected to a partner's conductor, in a portion on one end side in the lengthwise direction of the terminal fitting;
a housing attachment portion to be attached to a housing at an intermediate position in the lengthwise direction of the terminal fitting;
a board connection portion to be connected to a circuit board through soldering, in a portion on the other end side in the lengthwise direction; and
a protruding portion that protrudes, from a position between the housing attachment portion and the board connection portion, downward, namely in a direction that faces the circuit board and intersects the lengthwise direction,
wherein a lower end of the protruding portion is positioned on a lower side relative to a lower end of the board connection portion.

3. The terminal fitting according to claim 1,
wherein a lower end thereof that opposes the circuit board includes an inclined portion that is inclined upward from the board connection portion to a base end of the protruding portion.

4. The terminal fitting according to claim 3,
wherein a height position of an end portion on the inclined portion side of a base end of the protruding portion is set higher than a height position of an end portion on the opposite side to the inclined portion side.

5. The terminal fitting according to claim 1,
wherein the terminal fitting is shaped as a plate extending along the lengthwise direction, and the lower end thereof that opposes the circuit board is a plate thickness surface.

6. The terminal fitting according to claim 5,
wherein a rib that extends in a direction that intersects the lengthwise direction is formed on a plate surface of the protruding portion.

7. A connector comprising:
the terminal fitting according to claim 1; and the housing,
wherein the housing includes a hood portion, and the partner connection portion protrudes into the hood portion.

8. The connector according to claim 7,
wherein the housing includes a plurality of terminal insertion holes, the housing attachment portion is accommodated in one of the terminal insertion holes, and
when the housing is disposed on a surface of the circuit board, at least one of the plurality of terminal insertion holes is disposed within a plate thickness range of the circuit board, or is disposed on a lower side relative to a back surface of the circuit board.
